(19) United States
(12) Patent Application Publication
(10) Pub. No.: US 2002/0193132 A1
(43) Pub. Date: Dec. 19, 2002

(54) Quality of service assessment

(76) Inventor: Raymond Wu, Oberscherli (CH)

Correspondence Address: BIRCH STEWART KOLASCH & BIRCH, PO BOX 747, FALLS CHURCH, VA, 22040-0747, US

(21) Appl. No.: 10/167,409

(22) Filed: Jun. 13, 2002

(30) Foreign Application Priority Data
Jun. 15, 2001 (EP) 01 810 584.1

(51) Int. Cl. H04B 7/00

(52) U.S. Cl. 455/513; 455/450; 455/413

(57) ABSTRACT

In a communication system where a user can choose one of a plurality of different levels of Quality of Service (QOS) the invention enables the assessment of the service quality actually delivered to the user by determination of the actual service quality of the communication network and comparison of the actual service quality with the agreed target service quality.

### BACKGROUND ART

In some communication networks, i. e. GPRS (general packet radio service) or third generation mobile systems such as UMTS (Universal Mobile Telecommunications System) or WCDMA (Wideband Code Division Multiple Acces) the user can choose from different grades of quality of service (QOS). Once the user and the system have agreed on a particular QOS the network will provide this level of service quality to the subscriber.

In known communication systems there is no process or equipment available which enables to determine if the network fulfills its obligations that means if the network actually provides what it has promised.

### SUMMARY OF THE INVENTION

It is therefore an object of the present invention to provide a process and a device to decide whether the network fulfills its obligation or not.

This object can be achieved with the process defined by claim 1. According to the invention the process for an assessment of a quality of service, particularly a transmission quality of a communication network for data transmission involves the determination of the actual service quality of the communication network under that set of conditions under which the target service quality is defined. This actual service quality then is compared with the target service quality being agreed upon between the user and the network.

By measuring the actual service quality and comparing it to the target service quality it can be decided if the network fulfills its obligations or how often and to what extent it fails to fulfill them. This knowledge can be used for example as a basis for subscriber billing where the subscriber can be billed the full amount or he can be given discounts if the network did not fulfill its obligations. It can also be used as a basis for subscriber complaints when the user realizes that he did not get the agreed service quality or it can be used for network improvements. The network provider can for example track the network performance over time and the performance before and after improvements can be compared.

According to the invention the device for an assessment of a quality of service, particularly a transmission quality of a communication network for data transmission comprises means for the determination of the actual service quality of the communication network under that set of conditions under which the target service quality is defined. Furthermore it comprises means for carrying out a comparison of the actual service quality with the agreed target service quality.

From the following detailed description and from all the claims as a whole it will be clear to a person skilled in the art, that there exist more advantageous embodiments and combinations of characteristics of the invention.

### WAYS OF CARRYING OUT THE INVENTION

The drawing used for illustration of the examples shows:

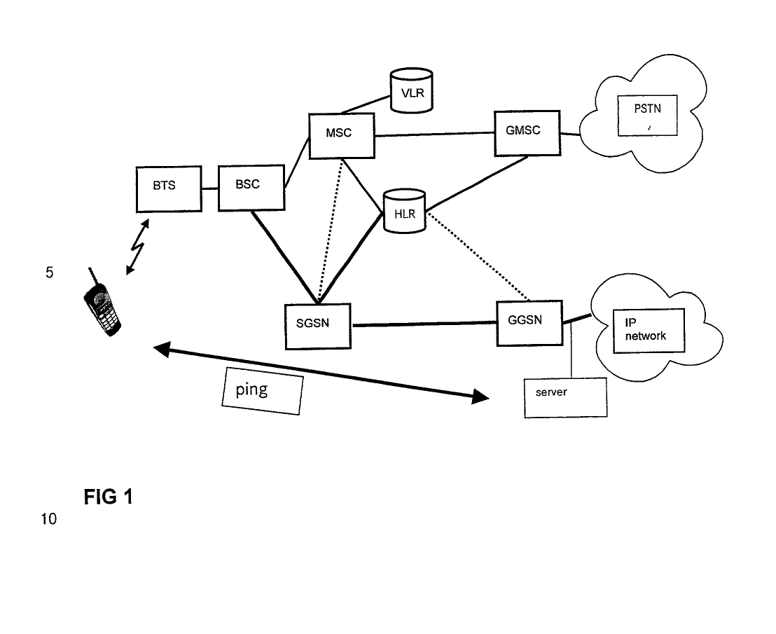

FIG. 1A schematic diagram of a GPRS network.

In cellular networks like GSM, there are no different grades of quality of service the subscriber can choose from. All subscribers essentially get the same service.

In GPRS and third generation networks like UMTS/WCDMA, there are provisions for the subscriber to specify what type of service he wishes to use. This is done at two levels:

a. the subscription of each subscriber can specify what (maximum) quality of service he is allowed to have,

b. when the subscriber actually uses the service, the network will negotiate (via signalling messages) what quality of service can be offered at that particular instant in time.

Once the negotiation between the network and the subscriber handy or any other communication device such as a handy with test equipment features is completed, there is then an agreement between the two parties that the network will provide this agreed level of quality of service to the subscriber.

It is therefore important that this type of agreement should be tested and/or verified to see if the network actually provides what it has promised.

While there are systems which measure the performance of the network in terms of some quality of service parameters, there are no known systems which carry out these measurements under the same exact conditions in which the quality of service parameters are specified or which compare the measured parameters to the agreed quality of service to deliver a verdict on whether the network has fulfilled its obligations.

This measurement and comparison is non-trivial in that several quality of service parameters could be interdependent, and should be measured only under controlled environment.

An example of these quality of service parameters is “round trip delay” (commonly known as ping delay).

FIG. 1 shows a GPRS network which illustrates the way of such a ping. The abbreviations mean: BTS—base station, BSC—base station controller, MSC—mobile service switching center, HLR—home location register, VLR—visitor location register, GMSC—gateway mobile service switching center, SGSN—serving GPRS support node, GGSN—gateway GPRS support node, WCDMA—Wideband code division multiple access, Ping—data packet sent from A to B and immediately returned by B to A, IP network—Internet protocol network (e.g. public internet), PSTN/ISDN—telephony network and Server—a computer where information is stored whereby the information can be accessed by authorized persons/computers.

A packet of data is sent from the handy, via BTS/BSC/SGSN/GGSN to the server, and the server immediately sends the same packet back to the handy. The time taken for this round trip i.e. from the time of packet sent by the handy to it arriving back to the handy again, is the round trip delay.

The magnitude of this delay is dependent, for example, on the size of the packet sent. If the packet size is large, then the network will sub-divide the packet into smaller blocks during transmission. This sub-division will take time and hence affect the round trip delay.

Another factor affecting the round trip delay would be “precedence”. This is, in itself, a quality of service parameter which forms part of the agreed conditions between the subscriber/handy and the network. Data packets with “low” precedence can be, in adverse traffic conditions, held up by the network in queues or discarded altogether.

The measurement of this round trip delay should therefore be done in the same exact conditions in which it is specified e.g. use only 128 byte long “high precedence” packets for round trip delay measurements.

In turn, the round trip delay will affect the data throughput when the subscriber transmits data. One reason for that is that if there are errors in the received data, the receiver will notify the sender to re-send. These messages which go between the sender and the receiver (e.g. the handy and the server) are all subject to the round trip delay. In general, the higher the round trip delay, the lower will be the user data throughput. However, this relationship is complex and is not always linear.

There are several quality of service parameters which can be used as a basis for the agreement between subscriber and network. They may include round trip delay, precedence, reliability, data throughput rate, speech quality and so on.

The invention therefore provides a system to deliver results to show if the quality of service conditions agreed between the subscriber communication device and the network have actually been met by the network when the subscriber uses the network's services. The system carries out measurements of these quality of service conditions, in the exact manner in which these conditions are specified. Preferably the system calculates results showing if the network has fulfilled its obligations and delivers them to the operator.

The system calculates these results by, for example, capturing from the subscriber handy or any other communication device (which forms part of the system and is connected to the control element of the system) the results of the quality of service negotiations i. e. the agreement between the subscriber and the network. This can be done either in real time or by checking the subscription of the concerned user. Then the system carries out the measurements to determine the actual service quality and finally shows, if the network has fulfilled its obligations during the whole period when the subscriber uses the network's services.

If the system finds, that the network fails to fulfill its obligations, the system furthermore can show how often the network fails and what percentage of obligation has actually been fulfilled.

1. Process for an assessment of a quality of service, particularly a transmission quality, of a communication network for data transmission, where the communication network and a user agree upon a target service quality which is defined under a set of conditions, characterized in that an actual service quality of the communication network which is actually available to the user is determined under said set of conditions and then the actual service quality is compared to the target service quality.

2. Process according to claim 1, characterized in that an assessment result is calculated depending on the comparison of the determined service quality with the target service quality.

3. Process according to any one of claims 1 or 2, characterized in that the target service quality is agreed upon between a service provider and a user with a communication device such as a handy before determination of the actual service quality where the agreed target service quality preferably is captured from the user's communication device.

4. Process according to claim 3, characterized in that the target service quality is chosen from a set of different target service qualities.

5. Process according to any one of claims 1 or 2, characterized in that for the determination of the actual service quality at least one parameter which is used to characterize the quality of service of the communication network is considered.

6. Process according to claim 5, characterized in that at least one of the parameters “round trip delay”, “precedence”, “reliability”, “data throughput rate” or “speech quality” is considered.

7. Process according to any one of claims 1 to 6, characterized in that the quality of service of a cellular mobile radio network, particularly a GPRS (general packet radio service) network is assessed.

8. Process according to any one of claims 1 to 7, characterized in that it is determined if the network reaches the target service quality or not while the user utilizes the service and if it fails to reach the target service quality how often it fails and what percentage of the agreed service quality it reaches.

9. Device for an assessment of a quality of service, particularly a transmission quality, of a communication network for data transmission, where the communication network and a user agree upon a target service quality which is defined under a set of conditions, characterized in that it comprises means for a determination of an actual service quality of the communication network which is actually available to the user and means for a comparison of the determined actual service quality to the target service quality.
